(19) United States
(12) Patent Application Publication
(10) Pub. No.: US 2015/0113778 A1
(43) Pub. Date: Apr. 30, 2015

(54) METHOD AND DEVICE FOR FINISHING WORK PIECES

(71) Applicant: MAG IAS GMBH, Göppingen (DE)

(72) Inventors: Leo Schreiber, Schwabisch Gmund (DE); Matthias Weber, Eislingen (DE)

(21) Appl. No.: 14/343,750

(22) PCT Filed: Sep. 18, 2012
(86) PCT No.: PCT/EP2012/068311

§ 371 Date: Mar. 7, 2014

(30) Foreign Application Priority Data
Sep. 18, 2011 (DE) 102011113757.6

(51) Int. Cl. B23Q 39/02; B23K 26/00; B23H 3/00; B23H 9/00; B24B 5/42; B23P 23/04

(52) U.S. Cl. CPC B23Q 39/023; B24B 5/42; B23P 23/04; B23H 3/00; B23H 9/00; B23K 26/0069; B23P 2700/07
USPC 29/6.01; 451/49; 29/888.08

(57) ABSTRACT

In order to shorten a process chain for material removing machining of a crank shaft after rough machining and after hardening a combination of circumferential turn milling as a first step and subsequent dry grinding as a second step is proposed according to the invention.

I. FIELD OF THE INVENTION

The invention relates to a method and a device for machining rotation symmetrical and also non rotation symmetrical components, in particular crank shafts and mass production, in particular bearing surfaces (of crank pin bearings and also journal bearings) of crank shafts to a useable condition, thus the condition when the crank shaft can be installed in an engine without additional material removal at the bearing surfaces.

Thus bearing surfaces are enveloping surfaces, thus a width of the bearing, and also the so called transom surfaces, thus the faces adjacent to the bearing width which are used for example for axial support.

### II. BACKGROUND OF THE INVENTION

Crank shafts in particular crank shafts for car engines with a high number of cylinders are known to be work pieces that are instable during machining and thus difficult to work on. Determining dimensional compliance of a finished crank shaft is primarily provided besides axial bearing width by assessing the following parameters:
Diameter deviation equals maximum deviation from predetermined nominal diameter of the bearing pinion.
Circularity equals macroscopic deviation from a circular nominal contour of the bearing pin determined by the distance of the outer and inner enveloping circle;
Concentricity=diameter deviation for a rotating work piece, thus deviation from a nominal bearing contour which a center bearing generates during rotation of the crank shaft on the one hand side caused by non ideal circularity of the center bearing pinion and on the other hand side of the eccentrical end pinion of the crank shaft which is thus only supported or clamped at its ends,
Roughness represented by mean individual roughness Rz=computational value representing the microscopic roughness of the surface of the bearing;
Support Portion=supporting surface portion of the microscopic surface structure which comes into contact with an applied opposite surface, and additionally for the crank pin bearings:
Stroke deviation=dimensional percentage deviation of the actual stroke (distance of the actual center of the crank pin from an actual center of the crank journal) from the nominal stroke and
angle deviation=deviation of an actual angular position of the crank pin from its nominal angular position relative to the journal axis and with respect to the angular position of the remaining crank pins designated in degrees or as a longitudinal dimension provided in circumferential direction relative to the stroke, whereby maintaining required tolerances for these parameters is limited by the available machining methods and also by the instability of the work piece and the machining forces. Also the efficiency and economics of the method are of great importance in practical applications, in particular for volume production where cycle times and thus production costs are of great importance, while singular pieces or prototypes are not subject to these limitations.

Typically material removal from the bearing of the formed thus cast or forged crank shaft was performed in three material removing machining steps:

### Step 1. Rough Dimension Machining

Chip removing machining through a defined edge, thus, the methods turning, turn-broaching, turn-turn-broaching, internal circular milling and external circular milling, face milling, in particular performed as high speed milling or combinations of these methods are used. The excess material to be removed is in a range of one-tenth millimeters.

Step 2. Fine dimension Machining:

Wet grinding through a hard, massive grinding tool, for example a grinding disc which typically rotates with its rotation axis parallel to the rotation axis of the crank shaft to be machined; the excess material to be removed is in a range of one-tenth millimeters.

For crank shafts that are difficult to machine, thus in particular long and thus very unstable crankshafts the grinding is also performed in several stages, for example in two stages by pre grinding and finish grinding.

Step 3: Primary Surface Structuring: Finishing through a typically stationary grinding device (grinding band or grinding stone) which is pressed against a circumference of the rotating bearing; the removed access material is presently in a 1/100 mm range or even pm range.

Thus, the processing has to be differentiated based on the material of the crank shaft (steel or cast iron) wherein in particular steel crank shafts which are preferably used for highly loaded components are hardened at the surfaces of the bearings after the first chip removing machining step. This causes renewed warping of the crank shaft which had to be compensated by grinding and finishing. Hardening cast iron crank shafts is currently typically omitted and can be completely avoided by using a cast material with greater hardness like e.g. GGG 60 or 70 and improved strength values.

In order to reduce the cost of crank shaft machining it is desired to reduce the machining of the bearings from three different machining steps to two different machining steps.

Omitting the first processing step in that forming, typically forging is performed precisely enough, so that only fine machining is required thereafter, has not been successful in practical applications at least for mass production so far. At least this, however, would have the consequence that in particular the material removal to be provided by grinding has to be greater than for a 3 step method. For material removal through wet grinding it is disadvantageous however that
the grinding sludge caused by the added coolant—lubricant is difficult and extremely expensive to dispose of;
there is a latent risk of an explosion due to the oil included in the coolant—lubricant e.g. during CBN grinding;
the amount of coolant—lubricant used is much greater for grinding than for chip removing machining methods, since the coolant—lubricant is additionally used for removing grinding dust out of a surface of the grinding disc through high pressure spraying;
in spite of all the above the risk of overheating the work piece is very high,
also the machining pressures impacting the work piece are greater than for chip removing machining, and
a microscopic surface structure is generated in which the grain boundaries torn up by the grinding grit are smeared close again through the subsequent grinding grit with removed work piece material, thus a surface structure with rather few ragged peaks but with peaks is provided that partially overlap like scales and which are more or less planar and bent.

Thus it was attempted in the past to minimize the complexity, thus the amount of investment and also machining times and similar for partially hardened work pieces, thus in particular machining after hardening.

Thus it was attempted in particular to eliminate wet grinding and to transition from chip removing machining for example directly to finishing as suggested by DE 197 146 677 A1 while predetermining defined transfer conditions with respect to the individual dimensional parameters.

Also EP 2 338 625 A1 proposes particular fine machining with a defined edge which shall replace the step of wet grinding, however, a finishing is optionally provided thereafter which shall not only improve shape and surface but also dimensional precision to a lesser extent.

Prior optimization attempts, however, do not sufficiently consider the options and in particular the possible combinations of the new machining methods with a defined edge and also with a non defined edge and without edge which meanwhile are also provided in variants for hard machining, thus for machining hardened work piece surfaces and can thus be used at the work piece after hardening.
during turn milling, thus milling at a rotating work piece, in particular external milling thus a milling with a disc shaped cutter with circumferential teeth fine adjustable cutting plates are used which are arranged on wedge systems of the base element of the cutter, wherein the cutting plates are adjustable precise enough so that also 60-100 cutting plates on a cutter provide very good circularity and diameter precision at the work piece.
for orthogonal milling using 2-8 cutting edges on the face yields an acceptable material removing performance without degrading surface quality too much since the cutting edges cannot only be adjusted very well relative to one another but additionally, which is also applicable for an external mill, the cutting edges are made from finest grain hard metal with a very fine grit so that also tearing up the grain boundaries is reduced. In particular, however, this simultaneously overcomes the previous conflict between hardness and elasticity of the cutting edge.
during longitudinal turning of the bearing locations there was a problem so far in that turning tools with different elbows were required for turning left and right corner portions and therefore typically a non avoidable step of 10-30 μ meters was provided in the transition portion of the two machining locations wherein the step could not be efficiently removed through finishing alone since due to the relatively imprecise self guiding support of the finishing tool a material removal has to be performed for removing the step that is many times greater which requires a large amount of finishing time.

A bearing can be machined with a single turning tool that is feedable in X-direction, moveable in Y-direction and additionally rotatable about a B-axis (single point turning) so that the bearing can be turned without producing a shoulder.
Tangential turning with a cutting edge that is oriented at a slant angle relative to the rotation axis of the work piece and moved along in a tangential or arcuate manner is mean while usable in series production, not only for center bearings but also for rod bearings. When it is not a primary goal for the produced surface to be free from spin grooves a high amount of surface quality is generated with good efficiency.
Dry grinding without a liquid coolant and lubricant can only provide very small material removal, in particular approximately 10-30 μm even when cooling and cleaning of the tool is provided with compressed air.
For finishing typically multi stage so called dimensional form finishing is used in which only in the first step in which a coarse grit is used a significant material removal up to approximately 30 μm is achieved and interrupted after measuring or continued.

The second step and the third step of finishing with finer grit produces material removal in a range of 5 μm and is performed time based and eventually used for surface structuring.

Furthermore there is electrochemical etching of surfaces today which is used for structuring surfaces, thus in particular removing the peaks of the microscopic surface structure.

It is well known that it is not only relevant for structuring to remove the peaks but it is also important to keep the valleys open to maintain them as oil reservoirs. In case this is not sufficiently achievable with the known methods like finishing, the known methods must be actively included, for example by including laser beam treatment.

Certainly the precision requirements on the customer side have also increased which are typically at 5 μm regarding circularity, quality level 6 with respect to diameter precision, thus for a car crank shaft approximately 16 μm and with respect to concentricity between 0.05 and 0.1 mm.

### III. DETAILED DESCRIPTION OF THE INVENTION

### a) Technical Object

Thus it is an object of the invention to reduce fine machining of the work pieces recited supra to provide usability in particular after hardening, in particular to reduce the number of process steps.

### b) Solution

The object is achieved by the characterizing features of claims 1, 2 and 24. Advantageous embodiments can be derived from the dependent claims.

Thus, it is an object of the present invention to machine the work pieces recited supra and in particular their bearings after chip removing rough machining which achieves a precision of one-tenth mm and possible subsequent hardening which causes additional warping.

The subsequently recited processing steps typically relate to the same machining location.

According to the invention it is presumed that a first finishing step is required after that, wherein the first finishing step is used for achieving dimensional precision and a second finishing step is used for achieving the respective surface quality.

The first fine machining step is a chipping with a defined edge. This can either be turn milling with an external milling bit which rotates parallel to the work piece during machining or an orthogonal milling bit whose rotation axis is oriented perpendicular or at a slant angle to the rotation axis of the work piece, or the turning, in particular in the form of single point turning which are all capable to machine down to tolerances of approximately 10 μm which, however, shall not always be fully utilized in the process chain according to the invention.

For the second fine machining step in particular material removal with an undefined edge like e.g. fine—dry grinding or finishing, thus in particular the fine steps of dimensional form finishing are available or also electrochemical hardening with or without pulsating loading of the electrodes.

Ideally the process chain only includes the first and second fine machining step.

If necessary a fine intermediary step is performed there between. The following is available dry grinding which only provides removing much smaller amounts of material compared to wet grinding for example at the most 150 μm, or tangential turning thus a method with a defined edge, or the coarse step of dimensional form finishing, or single point turning is another option in case this was not already selected for the first fine machining step.

It largely depends on customer requirements if a final fine finishing step is required after the second fine finishing step for structuring the surface.

A fine completion step of this type, in particular through ECM or band finishing can preferably only be performed in a particular circumferential segment of the work piece when there is a segment in which the load is higher than in other portions as it is the case for example for bearings of crank shafts.

This can be used in particular for introducing cavities as oil reservoirs into the work piece surface for improving lubrication and thus sliding properties for a longer time period.

For this purpose in particular a targeted laser impact can be used for achieving such cavities or in turn electrochemical etching, in case this was not already selected as a machining method for the second fine machining step.

Namely in this case the respective protrusions for burning the cavities into the work piece are already machined into the electrode for electro chemical etching and the cavities are introduced and the peaks of the microscopic surface structure are clipped off in one process step.

This way a shortening of the process chain is provided over the conventional process chain and in spite of increased customer requirements. This has the advantage that in particular wet grinding is prevented and additionally depending on the particular combination several process steps can be performed in the same machine and with the same clamping step.

Thus, the machining methods of the first and second fine processing step, besides electrochemical etching, can jointly by implemented in one machine and thus the work piece can be machined in one clamping step.

Even an additional fine intermediary step can be included therein regardless of the actual choice of the machining method for this fine intermediary step.

Even a laser unit for impacting the work piece surface can be additionally used in a machine that is a turning machine as a matter of principle, thus for a work piece that is drivable during processing and defined with respect to its rotational position (C-axis).

According to the present invention after the first fine machining step which is performed with a defined edge, a dry grinding or fine dry grinding shall be performed immediately thereafter, wherein this can be performed preferably in the same machine and clamping step as the first fine machining step with defined edge.

Preferably turn milling is used as a first fine machine step which is performed as external milling, especially grinding is in particular performed with a grinding disc that also rotates about a rotation axis parallel to the turning axis during machining. Thus, drive units for grinding disc and disc cutter can be used which are configured very similar or even identical. When fine dry grinding is performed directly after the first fine processing step, machining is performed to a precision of 15 μm for circularity and 15 μm or better for diameter. These are excess dimensions which are still removable with the very fine grit, and thus depending on the required final precision it is also possible to leave the fine dry grinding as a finishing step thus in particular not to let any band finishing follow, but at the most one fine finishing step for surface structuring, for example laser impact or introducing cavities in the work piece or leveling the surface peaks with electrochemical etching.

Another option is to perform dry grinding with a coarser grit and thus achieve greater material removal, but then perform finishing or electro chemical etching as a second fine machining step. In this case the first fine machining step with a defined edge is only performed to a precision of 25 μm for circularity and 30 μm for diameter, since these greater excess dimensions can still be removed through dry grinding due to the coarser grit used.

During fine dry grinding and also during coarser dry grinding preferably a dry cooling and cleaning of the grinding device for example with compressed air is provided at or proximal to the machining location.

Since in the instant case irrespective of the particular selected processing combination only the electrochemical etching is a wet machining, all other machining steps can be performed successively in the same machine and thus at the work piece in the same clamping step at the individual machining locations. Additionally this facilitates simultaneous machining of different machining locations in different processing steps.

Thus, not only the investment for the process is reduced, but in particular an occurrence of additional dimensional imprecisions is avoided which are inevitably provided when clamping and re clamping the work piece when machining is performed with the precisions cited.

Another advantage of the combination of peripheral milling with dry grinding is that both tools due to their basic disc shape and rotation about the Z-direction are not only configured similar but can be used on similar or even identical tool supports.

Thus, even the typically much higher cutting velocity of a grinding disc over a disc cutter can be omitted to use this advantage. Thus, for example the speed and/or cutting velocity of the grinding disc can be set at the most to three times, better only two times the value for the disc cutter which facilitates using partially or completely identically configured supports.

In particular for this purpose it is also useful to define the diameter of the grinding disc approximately in the order of magnitude of the diameter of the disc cutter, at the most, however 20% larger.

In order to further improve precision in the first fine machining step tools are used in which the cutting edges can be subjected to a fine alignment relative to the base element of the tool through wedge systems in order to achieve precisions in a range of 10 μm or below.

Additionally when using an orthogonal cutter, a cutter with two-eight cutting edges, in particular 4-6 cutting edges at the face is used which preferably may be distributed unevenly over the circumference in order not to cause any resonance frequency.

Additionally the orthogonal cutter is moved in engagement at the enveloping surface to be processed, typically starting at an outer circumference of the face of the orthogonal cutter in Y-direction relative to the rotation axis of the work piece during the engagement, thus by at least 40% better at least 50% in particular at the most 60% of the diameter of the orthogonal cutter, so that the problem of the cutting performance and cutting direction that is reduced in the center of the orthogonal cutter or which is not present at all due to the lack of cutting edges is solved in that the continuously performed axle offset causes all length portions of the bearing to be machined with sufficient precision.

For this purpose the work piece rotates at least five times while performing the axis offset of the orthogonal cutter, the work piece better rotates at least 10 times or even better at least 20 times.

The speed of the orthogonal cutter should thus be at least 80 times, better 100 times or even better 130 times the speed of the work piece.

For an external cutter, however, the diameter of the cutter shall be at least 40 times, better 45 times of a stroke of the crank shaft to be machined.

When processing hardened surfaces the cutting edges of the chipping tools with defined edge are typically made from CBM or hard metal, however, are preferably made with a grit of below . . . and thus rather elastic in spite of having sufficient hardness.

In case electrochemical etching is selected in the second fine processing step, thus a material removal of 30 μm at the most, better only 20 μm is performed, but a removal of at least 5 μm since only this achieves sufficient smoothing of the microscopic surface structure to a arm portion of at least 50% which is the general goal for the second fine machining step.

A further acceleration of the production process can be achieved in that the second fine machining step, in particular electrochemical etching only machines the circumferential portion of the lift bearing, thus the rod bearing at the crank shaft which is loaded with the pressure of the connecting rod upon ignition which is always the same circumferential portion.

In particular only the respective half circumference of the rod bearing is processed in the second fine machining step.

This way the first fine machining step can be used for machining the lift bearings thus the rod bearings in the same clamping step and in particular the same clamping step as the proceeding coarse machining which is of interest in particular when hardening is not performed in between or an inductive hardening is also performed in the same machine and in the same clamping step.

In particular in the second fine machining step, this can certainly also be performed in the first fine machining step, the crankshaft is supported with a vertical support and thus at a bearing directly adjacent to the bearing to be processed.

This generates imprints of the stationary support on the supported bearing circumferences, wherein the imprints are not relevant with respect to dimensions and surface quality but shall be finished for optical reasons in that the imprints are removed in a last fine machining step which is facilitated in that the support through the adjacent stationary support is always on the side of the advance direction of the last fine machining step.

In the first fine machining step the flange and the pinion are advantageously machined while the crank shaft is supported at least in radial direction at the main bearing that is respectively adjacent to the respective machining location, in particular with a vertical support or also at adjacent bearings directly with a clamping chuck.

### c) EMBODIMENTS

Embodiments of the invention are subsequently described in more detail with reference to drawing figures, wherein:

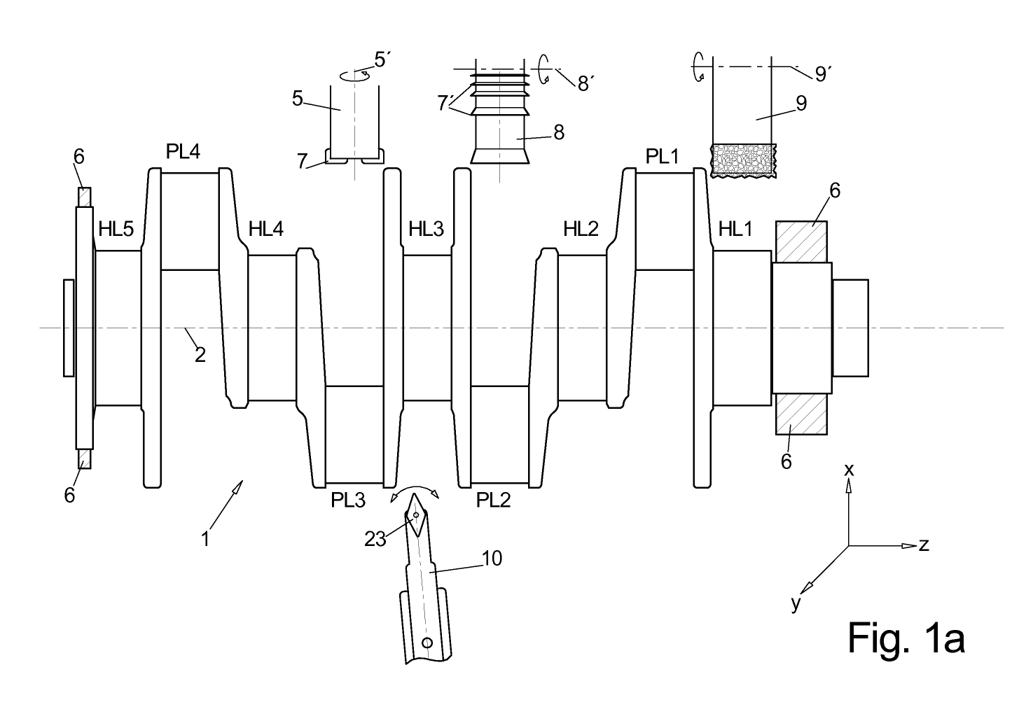

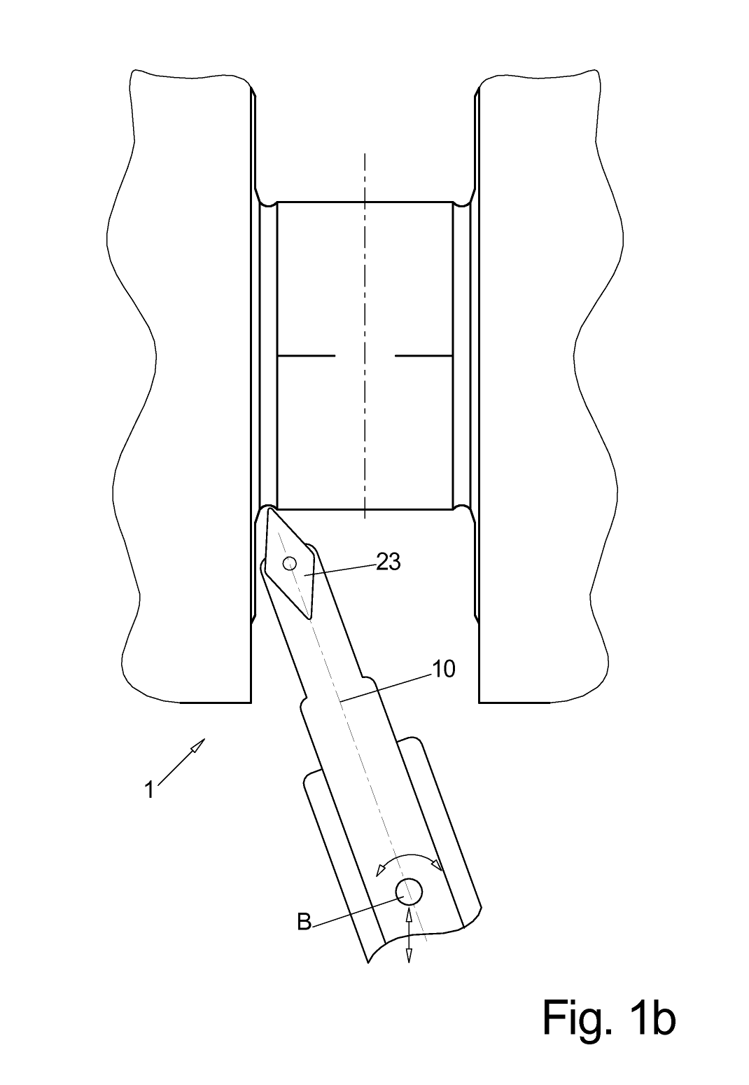

FIG. 1 a, b: illustrates a typical crank shaft in a side view and an enlarged individual bearing;

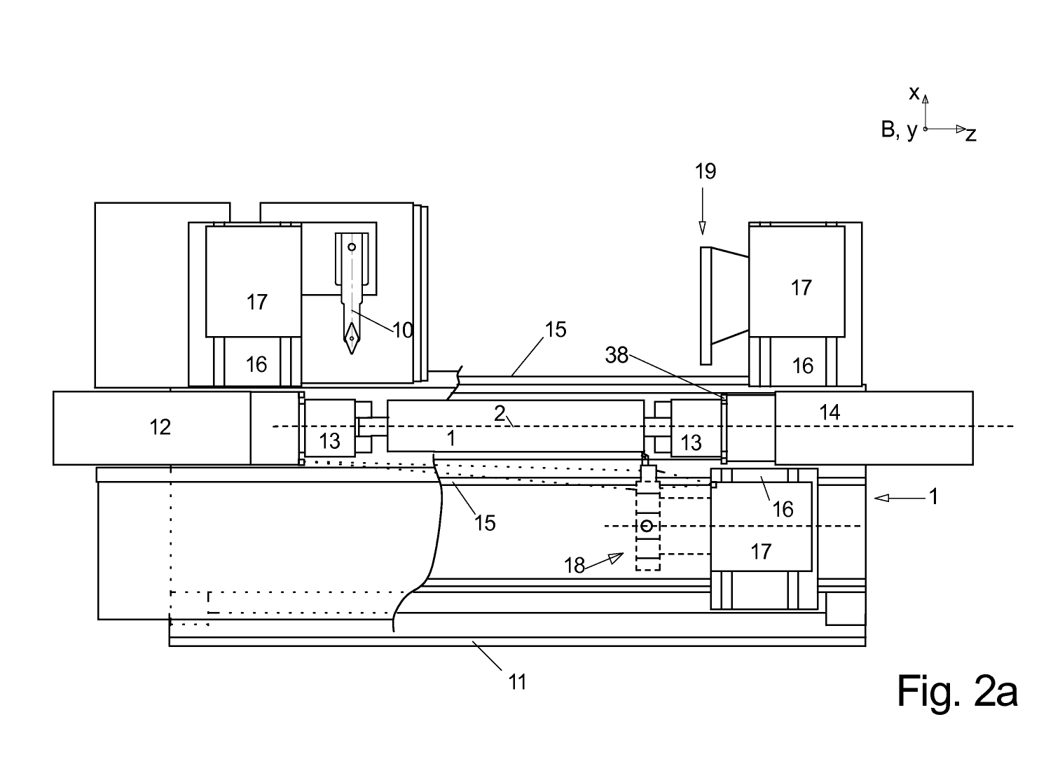

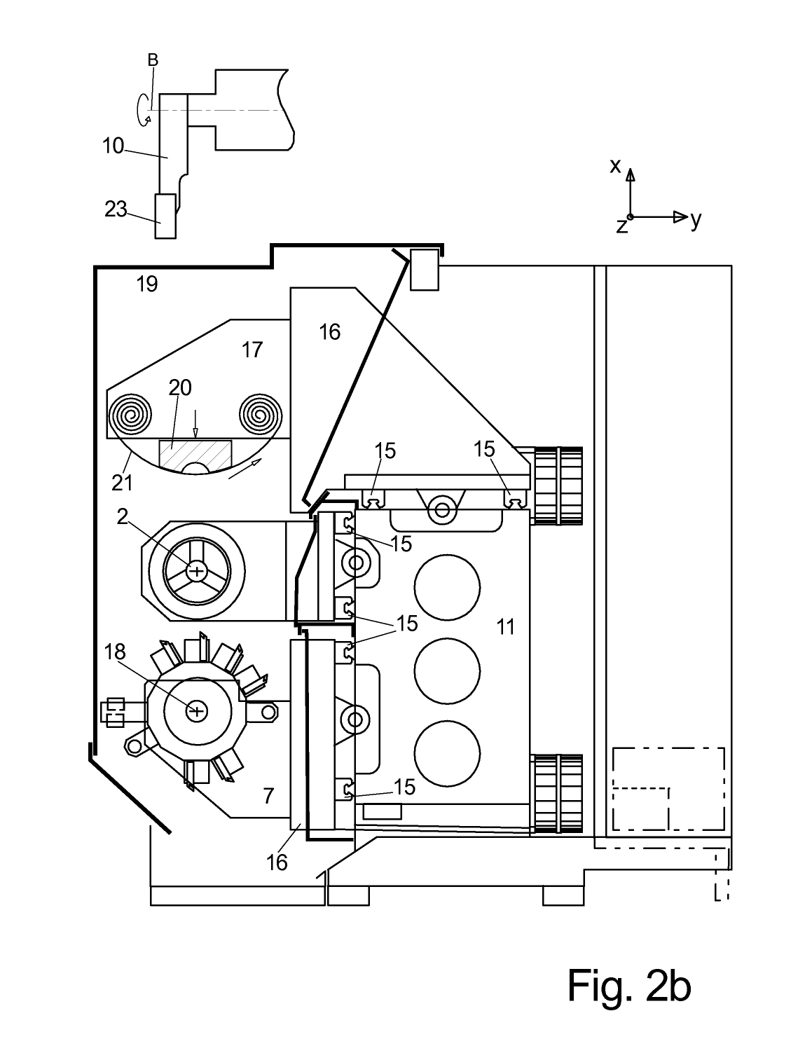

FIG. 2a, b: illustrates a turning machine with supports arranged above and also below the turning axis;

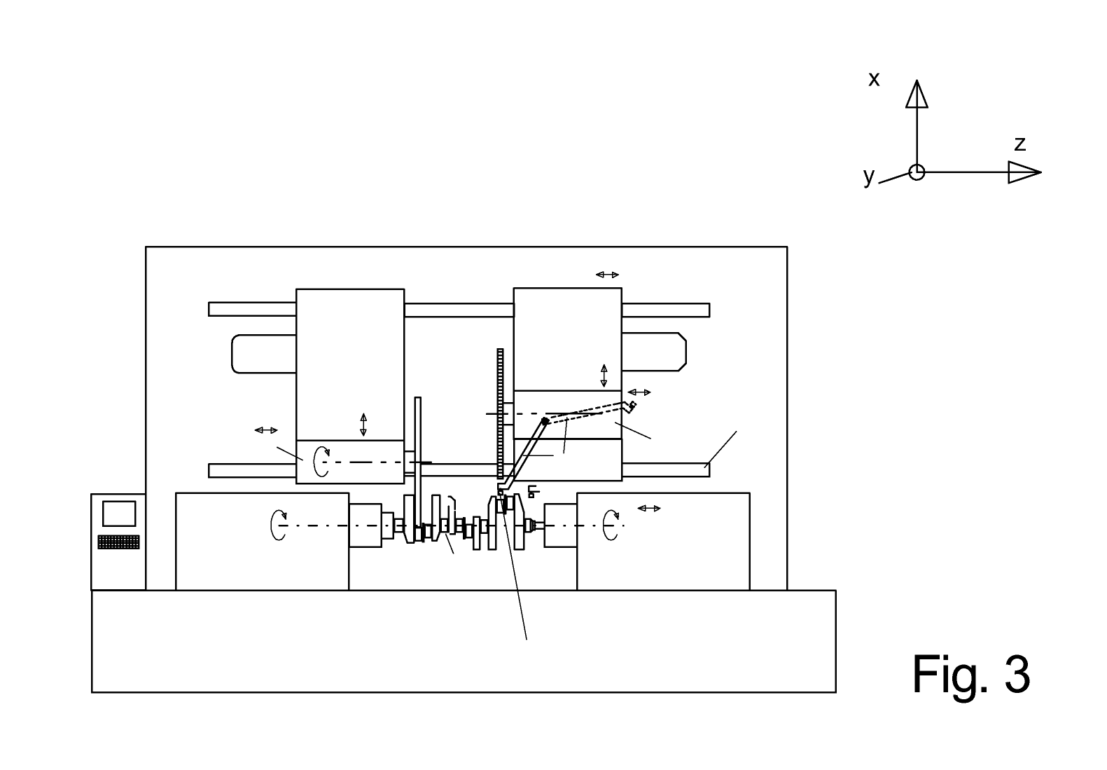

FIG. 3 a, b: illustrates a turning machine with supports only arranged above the turning axis;

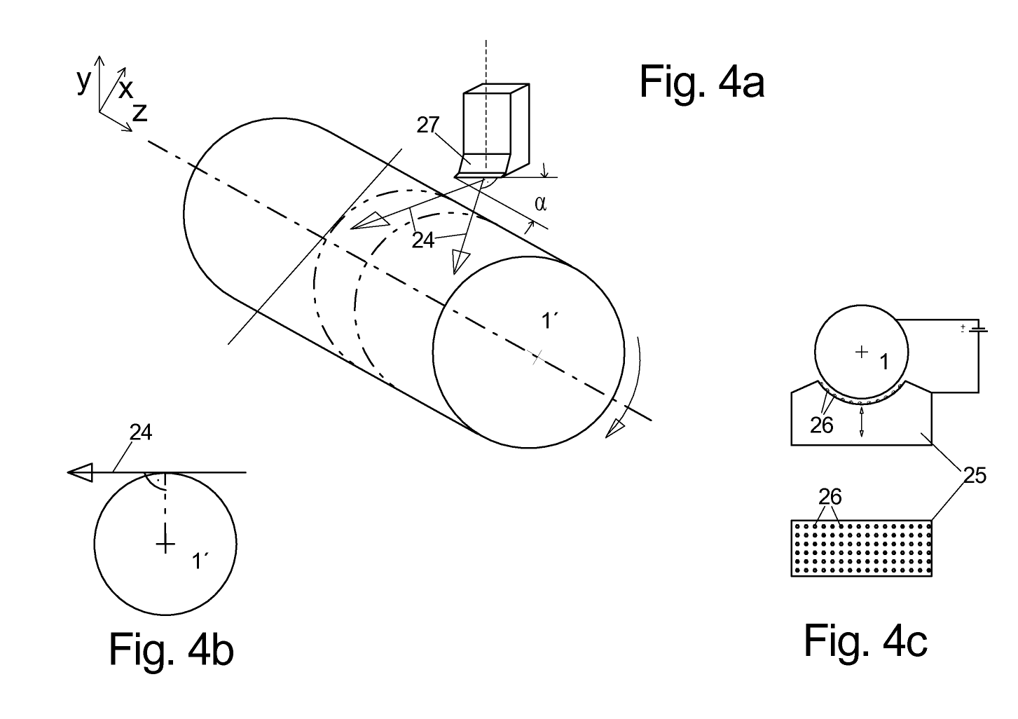

FIG. 4 a, b: illustrates different processing situations at a symbolized work piece;

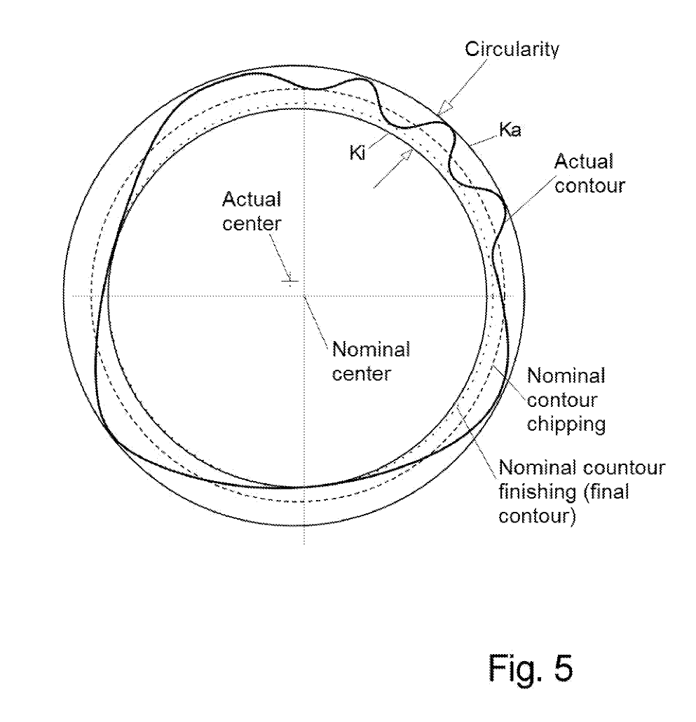

FIG. 5: illustrates dimensional deviations in a cross section of a bearing; and

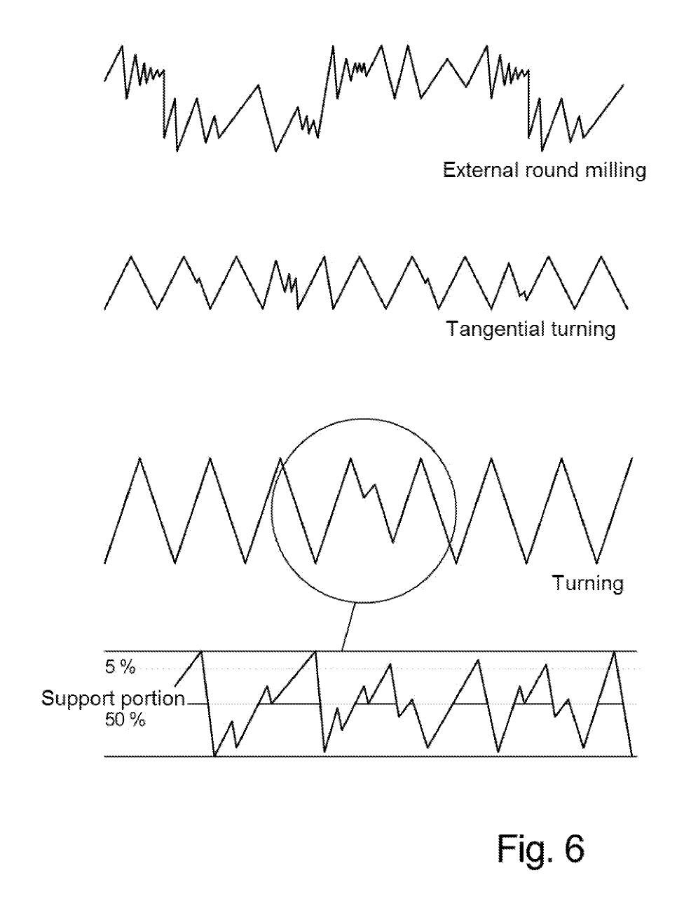

FIG. 6: illustrates microscopic surface structures at a work piece surface.

FIG. 1a illustrates a side view of a typical crank shaft 1 of a four cylinder combustion engine, thus with four eccentrical lift- or rod bearings PL1-PL4 and a total of 5 main bearings HL1-HL5 arranged adjacent thereto, wherein the main bearings are arranged on the subsequent rotation axis on which the crank shaft 1 is clamped in a turning machine that is not illustrated in more detail, wherein the rotation axis is also designated as rotation axis 2 in the illustration of FIG. 1, thus through radial clamping with clamping jaws 6 at the flange 4 at the one end and the pinion 3 at the other end of the crank shaft 1.

The invention relates in particular to machining the enveloping surfaces of the bearings, thus the main bearings and the rod bearings including the adjacent side surfaces, the so called mirror surfaces.

Above and below the crank shaft 1 machining tools are illustrated in an exemplary manner from the top left to the right:
on the one hand side an end mill 5 whose rotation axis 5′ is perpendicular to the rotation axis 2 which is typically defined as Z-axis in a 3 dimensional coordinate system for turning machines;
on the face of the end mill one or plural, preferably 2-8 cutting edges 7 are arranged which extend to the circumferential surface of the end mill 5, so that a bearing can be machined in a chip removing manner through contacting the rotating end mill 5 at an enveloping surface of the rotating bearing.
adjacent thereto a disc cutter 8 is arranged whose rotation axis 8′ is parallel to the Z axis and on whose circumference a large number of cutting edges 7′ is arranged which extend along the entire width of the circumferential surface and radially over the outer edge portion of the disc shaped base element of the disc cutter 8.

Due to the large number of typically 80 cutting edges or cutting plates 23 which have to be adjusted at a disc cutter 8 with for example 700 mm diameter the exact adjustment in radial and in axial direction in sync with all cutting plates is very time consuming.
on the right side adjacent thereto a grinding disc 9 is illustrated that rotates about a rotation axis 9′ that is arranged in Z-direction which is covered in her enveloping portion and in the adjacent face portions with abrasive grit, typically hard metal, ceramics or CBN and typically has an axial extension that is measured in Z-direction like the disc cutter 8, wherein the axial extension corresponds to the respective bearing.

Below the crank shaft a turning tool 10 configured as a single point turning tool is illustrated, wherein the turning tool does not extend exactly in X-direction but at a slight slant angle thereto in a direction towards the bearing and can contact the bearing in order to be able to also turn one of the corners of the bearing.

In order to turn both corners including the enveloping surfaces without stopping and thus without a shoulder with the same turning tool 10, this turning tool 10 as illustrated in FIG. 1 b in a detail view is pivotable about the B-axis in addition to a moveability in X-direction and certainly sufficiently slender in order to move in the bearing.

It is appreciated that machining one of the rod bearings PL1-PL4 at the crank shaft rotating about the main bearing axis, the engaging tools additionally have to perform a feed movement in X-direction and for the end mill 7 and for the cutting tool 10 an additional feed movement in Y-direction is required in order to be able to follow the orbiting rod bearing.

FIG. 2a and b illustrate an embodiment of a turning machine in a frontal view in Z-direction which can be used for machining work pieces like crank shafts with the methods according to the invention.

As illustrated in FIG. 2b a spindle stock 12 is arranged in front of the vertical front face of the machine bed 11 in its upper portion, wherein the spindle stock 12 supports a clamping chuck 13 that is drive able to rotate and includes clamping jaws 6. An opposite spindle stock 14 is arranged opposite to the spindle stock 12 wherein the opposite spindle stock 14 also supports a clamping chuck 13 so that a work piece, for example a crank shaft 1, can be received with both its ends on the rotation axis 2, which extends in Z-direction, in one respective clamping chuck 13 and can be driven in rotation.

On the front side of the bed 11 below the rotation axis and on the flat top side of the bed 11 longitudinal guides 15 are arranged respectively extending in pairs in Z-direction, wherein tool units are moveable on the longitudinal guides, in this case one tool unit on the lower longitudinal guides and two tool units on the upper longitudinal guides 15.

Each tool unit is made from a Z-slide 16 that is moveable along the longitudinal guides 15 and an X-slide 17 extending on the Z-slide and moveable in X-direction, wherein the tool or the tool unit are mounted on the X-slide.

In the unit below the rotation axis 2 this is a typical tool revolver 18 with a turning tool 10 inserted therein configured as a star revolver and with a pivot axis that extends in Z-direction.

The left upper unit is an individual turning tool 10 in single point configuration, thus pivotable about the B-axis which extends approximately in X-direction and thus moveable in X-direction also in accordance with the pivot movement.

The right upper unit is a finishing tool 19 which can make a circumferential surface at the work piece smoother.

In FIG. 2b this finishing tool 19 is illustrated viewed in Z-direction. Therein it is evident that this tool includes a finish form piece 20 with a cavity according to the convex circumferential surface of the work piece to which it shall be attached, e.g. configured as a semi circle and a finish band 21 which is run over the contact surface of the form piece 20 and is wound on a respective storage roll with its ends.

Also a single point turning tool is illustrated again in this view adjacent there to in FIG. 2b.

FIG. 3a on the other hand side illustrates a turning-milling machine in which in turn a crank shaft 1 is supported again as a work piece by spindle stock and opposite spindle stock 14 between two clamping chucks oriented against one another drive able in rotation about the rotation axis 2 which is configured as a C-axis, like in the turning machine of FIGS. 2.

In this case longitudinal guides 15 are only arranged at the machine bed 11 above the turning axis 2, wherein two tool units with Z-slides 16 and X-slides 17 running thereon are provided.

In this case the right X-slide 17 supports a disc cutter 8 which rotates parallel to the rotation axis as indicated in FIG. 1 and the left Z-slide 17 supports a grinding disc 9 which also rotates about an axis parallel to the Z-axis.

Additionally a measuring unit 22 is provided at the right X-slide 17, wherein the measuring unit can be activated and deactivate by pivoting in order to perform measurements at a circumferential surface with respect to diameter, circularity, etc. without unclamping or re clamping the work piece in that a measuring probe to be approached in X-direction contacts the circumferential surface.

In FIG. 3b this is illustrated viewed in Z-direction with reference to an individual cutting plate 23 of the disc cutter 8, wherein the individual cutting plate is supported in radial direction at two wedges that run towards each other, wherein at least one wedge is adjustable in circumferential direction, wherein the cutting plate 23 can be adjusted very precisely in radial direction. An analogous adjustment device is also provided for the axial direction.

FIG. 4a illustrates processing a portion of a circumferential surface not with reference to a crank shaft but with reference to a circumferential work piece which could be the circumferential surface of the lift bearing or rod bearing, through tangential turning.

Thus, a straight or concave cutting edge that is arranged skewed to the rotation axis of the rotating work piece is moved in a tangential moving direction 24 contacting at the circumferential surface of the work piece, for a straight edge in a tangential in a straight direction and for a convex edge in a tangential, arcuate direction about a pivot axis which extends parallel to the rotation axis 2.

Thus, only very small excess dimensions can be removed; however the machining result is very precise and has an excellent surface.

In FIG. 4c electrochemical etching is illustrated.

Thus, an EMC electrode 25 whose contact surface is advantageously adapted to the contour of the circumference of the work piece produced and which includes a respective cavity is moved towards the work piece, wherein an electric current or an electric voltage is applied between the work piece on the on hand side and the electrode 25 on the other hand side and additionally a salt solution or acid is introduced between both of them.

When these parameters are selected accordingly, portions proximal to the surface, in particular the peaks of the microscopic surface structure of the work piece are etched off and carried away in the salt solution. For improvement purposes the electrode 25 can be moved in a pulsating manner radially and axially in order to optimize extraction through salt solution or acid.

As a matter of principle the work piece can be rotated about the rotation axis 2.

However, when a plurality of small microscopic protrusions 26 is provided on the contact surface of the electrode surface 25 like in the illustrated case which are used for producing respective microscopic cavities in the surface of the work piece which are subsequently used as oil reservoirs, the work piece certainly has to be machined while standing still.

Otherwise such microscopically fine cavities, typically only with a depth of a few μm, can also be produced through laser impact.

Thus FIG. 6 has different microscopic surface structures which are typical for different chip removing machining methods with a defined edge.

Longitudinal turning yields a typically uniform saw tooth profile whose roughness Rz is in the range of 10-20 μm.

The surface structure after tangential turning is similar as a matter of principle; however it has a much lesser distance between peaks and valleys with an Rz of approximately 5 μm.

For external circular milling, however, it is typical that the surface structure includes portions thereafter which are microscopically on different levels according to the impact of the individual milling blades after one another on the work piece and the very fine facets on the work piece thus formed.

The lower portion FIG. 6 illustrates an enlarged microscopic structure and the desired 50% support portion after removing the peaks which is approximately desired for bearings.

Thus, it also becomes clear that with increasing support portion, thus no matter whether through finishing or fine grinding, the surface to be treated with the tool becomes larger and larger and thus the removal in radial direction becomes slower and slower.

FIG. 5 illustrates—viewed in the direction of the Z axis—a sectional view through a bearing e.g. of a crank shaft whose nominal contour is an exactly circular contour. In practical applications, however, this is a non circular contour that is generated at least after the chip removing machining with a defined cutting edge.

Thus in order to determine circularity an inner enveloping circle and an outer enveloping circle is applied to the actual contour and the distance of the two enveloping circles defines circularity.

Additionally also an actual center of the respective bearing may not exactly coincide with the nominal center which is the case in particular for rod bearing pinions and has a negative influence on concentricity precision.

Furthermore, the nominal contour after finishing is defined, thus the final contour which is accordingly radially within the nominal contour after chipping with the defined edge is completed.

### REFERENCE NUMERALS AND DESIGNATIONS

1 crank shaft
1′ work piece
2 rotation axis
3 pinion
4 flange
5 end mill
5′ rotation axis
6 clamping jaw
7, 7′ cutting edge
8 disc cutter
8′ rotation axis
9 grinding disc
9′ rotation axis
10 turning tool
11 machine bed
12 spindle stock
13 clamping chuck
14 opposite spindle stock
15 longitudinal guide
16 Z-slide
17 X-slide
18 tool revolver
19 finishing tool
20 finishing form piece
21 finishing band
22 measuring unit
22a measuring probe
23 cutting plate
24 tangential movement direction
25 ECM electrode
26 protrusion
27 tangential turning tool

1. A method for ready to used finish machining workpieces with rotation symmetrical and non rotation symmetrical, concentric and also eccentric circumferential surfaces and adjacent side surfaces, having crankshafts wherein after chipping coarse machining and subsequent partial hardening of the circumferential surfaces a first fine machining of the circumferential surface is performed, said method comprising the steps of:
directly after the first fine machining step with defined edge, a dry grinding or fine dry grinding is performed and in a first fine machining step with a defined edge machining is only performed to a precision of 25 μm for circularity and 30 μm for diameter.

2. A method for finishing work pieces ready to use with rotation symmetrical and non rotation symmetrical circumferential surfaces which are concentric and also eccentric and adjacent side surfaces, including crank shafts wherein fine machining of the circumferential surfaces is performed in the following steps after a chip removing coarse machining and subsequent partial hardening of the circumferential surfaces, said method comprising the steps of:
performing a first fine machining step with a defined cutting edge, through
turn milling in the form of external milling or orthogonal milling or,
turning, in the form of single point turning,
performing a fine intermediary step through,
dry grinding,
tangential turning
coarse step of dimensional form finishing, or
single point turning,
turn milling with edges oriented more precisely than 5 μm
second fine machining step through
fine dry grinding,
fine step finishing of dimensional form finishing, or
electrochemical etching (ECM), with pulsating loading of the electrode (PCM), and
performing a fine completion step for structuring the surface of cavities through,
laser impact or,
electrochemical etching (ECM).

3. The method according to claim 1 characterized in that turn milling, in the form of external milling or orthogonal milling is used as a first fine machining step.

4. The method according to claim 1 characterized in that after dry grinding a second fine machining step is performed through finishing for electrochemical etching (ECM).

5. The method according to claim 1 characterized in that for fine dry grinding directly after the first fine machining step in the first fine machining step advantageously machining is performed for circularity precision to 15 μm or better and for diameter precision to 15 μm or better and no band finishing is performed after fine dry grinding.

6. The method according to claim 1 characterized in that a fine completion step is performed through laser impact and/or introducing cavities in the work piece is performed through ECM.

7. The method according to claim 1 characterized in that a machining is performed through ECM and/or band finishing only in the circumferential segment of the bearing where the main load is applied when used in a combustion engine.

8. The method according to claim 1 characterized in that the first fine machining step is performed with a defined edge and dry grinding and/or fine dry grinding and/or finishing is performed in the same machine and in the same clamping step of the work piece.

9. The method according to claim 1 characterized in that dry grinding and/or fine dry grinding and/or turn milling through external milling or orthogonal milling of the first fine machining step is performed at different machining locations of the work piece simultaneously.

10. The method according to claim 1 characterized in that a diameter is selected for the grinding disc for dry grinding or fine dry grinding which corresponds at least to the diameter of the disc cutter when performing the external milling for the first fine machining step or a grinding disc that is greater by 20% at the most.

11. The method according to claim 10 characterized in that the speed and/or the cutting speed of the grinding disc is three times at the most, better two times at the most of the value of the disc cutter and an identically configured support is used for disc cutters and grinding discs.

12. The method according to claim 1 characterized in that the first tine machining step includes
machining main bearings (HL) through single point turning, and
machining lift bearings or rod bearings (PL) through turn milling in the form of circumferential milling and
turn milling uses cutting speeds of 150-400 m/min and/or machining is performed for circularity down to a precision of 10 μm or more precisely and or diameter down to a precision of 10 μm when finishing or ECM follows,
single point turning uses cutting speeds of 250-400 m/min, and/or machining is performed for circularity at least down to a precision of 10 μm or more precisely and for diameter down to a precision of 10 μm or more precisely.

13. The method according to claim 2 characterized in that in case the second fine machining step is electrochemical etching (ECM), the electrode includes protrusions in a defined distribution over its effective surface wherein the protrusions have a height of 10 μm at the most for introducing cavities into the work piece surface.

14. The method according to claim 1 characterized in that multi stage finishing includes laser impact after the last finishing step.

15. The method according to claim 2 characterized in that orthogonal milling uses a cutter with 1-10 cutting edges which are unevenly distributed over a circumference.

16. The method according to claim 2 characterized in that milling uses tools with cutting edges which facilitate a fine alignment 5 μm or more precise relative to a base element of the tool through wedge systems.

17. The method according to claim 2 characterized in that orthogonal milling includes advancing the engaging cutter in Y-direction by at least 20%, of its diameter, wherein the work piece performs at least 5 revolutions during that time period.

18. The method according to claim 2 characterized in that orthogonal milling is performed at a speed of the orthogonal cutter that is at least 80 times the speed of the work piece.

19. The method according to claim 2 characterized in that the cutting edges of the milling cutter are made from micro grain hard metal with a grit of 0.2 μm-0.5 μm.

20. The method according to claim 2 characterized in that electrochemical etching (ECM) includes a material removal of 30 μm at the most, but at least 5 μm.

21. The method according to claim 1 characterized in that in a first fine machining step lift bearings and rod bearings are machined in the same clamping step and in the same clamping step as the preceding coarse machining and thus the crank shaft is supported at the flange and pinion with clamping chucks.

22. The method according to claim 1 characterized in that in a second fine machining step the crank shaft is respectively supported with a vertical support at a bearing that is already fine machined in a first step, wherein the vertical supporting is performed at a main bearing that is directly adjacent to the bearing to he machined, and in a last fine machining step the vertical support impressions that are produced on the machined bearings are removed, wherein the support is always provided on a side in the advance direction in this last step.

23. The method according to claim 1 characterized in that in the first fine machining step besides the center and lift bearings also the flange and the pinion are machined wherein the crank shaft at the end adjacent to the machining location is supported through a centering tip at the clamping jaws pulled back on the opposite side and supported on the other side in a clamping chuck.

24. A turning machine for finishing work pieces ready to use with rotation symmetrically and optionally non rotation symmetrical, concentric and optionally also eccentric circumferential surfaces and adjacent side surfaces, having crank shafts, said turning machine comprising:
a machine bed (11),
a spindle stock (12), with clamping chuck (13),
an opposite spindle stock (14) with clamping chuck (13)
a controlled C-axis,
at least one vertical support,
a turning unit or a milling unit with a disc cutter or with an orthogonal cutter, wherein the orthogonal cutter includes a Y-axis in addition to the X- axis,
a grinding unit, and
optionally a finishing unit and/or a grinding disc (9) rotating about the C-axis.

25. The turning machine according to claim 24, characterized in that
the turning machine includes a laser unit for impacting the circumferential surface of the work piece and/or
an activatable and de-activatable measuring unit (22).
